(19) United States
(12) Patent Application Publication
(10) Pub. No.: US 2002/0006314 A1
(43) Pub. Date: Jan. 17, 2002

(54) Methods and devices for use in installation of underwater conduits

(76) Inventor: Stewart K. Willis, Aboyne (GB)

Correspondence Address: Brent P. Johson, Esq., SHERIDAN ROSS P.C., 1560 Broadway, Suite 1200, Denver, CO, 80202-5141, US

(21) Appl. No.: 09/875,395

(22) Filed: Jun. 5, 2001

(30) Foreign Application Priority Data
Jun. 5, 2000 (GB) 0013565.7

(51) Int. Cl. F16L 1/12

(52) U.S. Cl. 405/168.2

(57) ABSTRACT

The invention relates to a method of protecting an underwater conduit (100) against collapse, due to high hydrostatic pressures At least one bracing device (106) is applied around the external circumference of the conduit so as to define locally a region of increased wall thickness, and the internal surface of the device is bonded to the external surface of the conduit. This inhibits separation of the two surfaces and thereby helps to prevent collapse of the conduit.

The invention relates to methods and devices for protecting underwater conduits from progressive buckling, in particular to arrest the propagation of a bifurcation or axial buckle. The invention finds application in pipelines for offshore gas and oil production, although it is not limited to any particular application.

When laying pipe in very deep water a depth can be reached where the pressure will cause an existing dent in the pipe to become a bifurcation (axial) buckle. This buckle then propagates rapidly along the length of the pipeline until it arrives at a depth where the pressure is less than the propagation pressure. This can cause the total loss of many kilometers of pipeline. Moreover, the buckle results in a loss of volume of the pipe being laid (and hence the mass of water displaced) without any loss of mass of the pipe itself. The weight of the suspended pipe string being laid then rapidly increases, and may cause overloading of the lay vessel's equipment, leading to the loss of the pipe and danger to personnel onboard.

It is common practice to either increase the wall thickness of all of the pipe, thereby incurring considerable cost and increasing the load on the lay vessel, or to install thickened sections of pipe at intervals along the pipeline to arrest the propagation. This latter solution is problematic when the pipe laying system involves the plastic deformation of the pipe during bending within the lay system as the change in wall thickness causes local (transverse) buckling. One such pipe laying system is disclosed in U.S. Pat. No. 5,975,802, where sections of rigid pipe are welded to form a continuous pipeline on the deck of the laying vessel, and then bent upwards and downwards before being straightened and paid out over the stem of the vessel. Other systems are known in which the continuous pipeline is formed onshore, and reeled onto the vessel.

Externally applied clamps have been tried by many experimenters over the years, but it is generally accepted that they do not work reliably as the buckle runs through the clamp. It is believed that this happens as the crown of the buckle plastically deforms into the bore of the pipe, which can not be prevented by clamping alone.

It is an object of the invention to provide an improved form of buckle arrestor compatible with pipe laying systems which bend the pipe. The inventor has recognized that the problems with known externally-applied clamps can be addressed by positively bonding the pipe to the inside of the clamp so that the circularity is maintained.

In a first aspect, the invention provides a method of protecting an underwater conduit against collapse, wherein at least one bracing device is applied around the external circumference of the conduit so as to define locally a region of increased wall thickness, and wherein an internal surface of the device is bonded to the external surface of the conduit so as to inhibit separation of the two surfaces and prevent collapse of the conduit.

The device may be applied during pipe laying operations. In the case of operations in which the conduit is bent and then straightened as it is paid out, the device may be applied after straightening of the pipe.

The device may alternatively be applied to existing sub-sea conduit installations.

In a preferred embodiment, an externally applied sleeve, collar or clamp is proposed, comprising a plurality of segments such that each segment can be laid upon the conduit prior to tightening and fixing. Modern ultra-high-strength adhesive is applied to the mating surfaces of the conduit and the device, which device may then tightened in place.

The number of segments in the clamp may vary from one upwards, although three or four segments is considered most practical, due to the need for (i) fitting around the conduit and (ii) applying pressure around the circumference of the conduit and device during curing of the adhesive.

The invention further provides a device for use as a buckle arrestor on an underwater conduit, the device comprising one or more parts adapted to be formed into a cylindrical collar surrounding and bonded to the external surface of the conduit so as to increase its thickness and resistance to inward collapse.

The device may comprise a set of part-cylindrical segments adapted to form said cylindrical collar by fitting around and bonding to said conduit. The number of segments may be three or four.

The invention yet further provides an underwater installation wherein rigid conduits are protected against inward collapse by the provision of bracing devices at regular intervals along a length of conduit, wherein each bracing device comprises one or more parts formed separately from the conduit and applied around the external circumference of the conduit so as to define locally a region of increased wall thickness, and wherein an internal surface of the device is bonded to the external surface of the conduit so as to inhibit separation of the two surfaces and prevent collapse of the conduit.

Said parts may in particular form a cylindrical collar. Said bonding may be by adhesive. The adhesive may be an epoxy resin.

### BRIEF DESCRIPTION OF THE DRAWINGS

Embodiments of the invention will now be described, by way of example only, with reference to the accompanying drawings, in which:

FIG. 1 illustrates schematically the laying of a continuous subsea pipeline with buckle arrestors (parts not to scale);

FIG. 2 illustrates the problem of bifurcation buckling within a known type of clamp;

FIG. 3 is illustrates a novel process of fitting a buckle arrestor to the pipeline in the method of FIG. 1; and

FIG. 4 illustrates the completed assembly, on a cross-section IV-IV′ of the pipeline shown in FIG. 1.

### DETAILED DESCRIPTION OF THE EMBODIMENTS

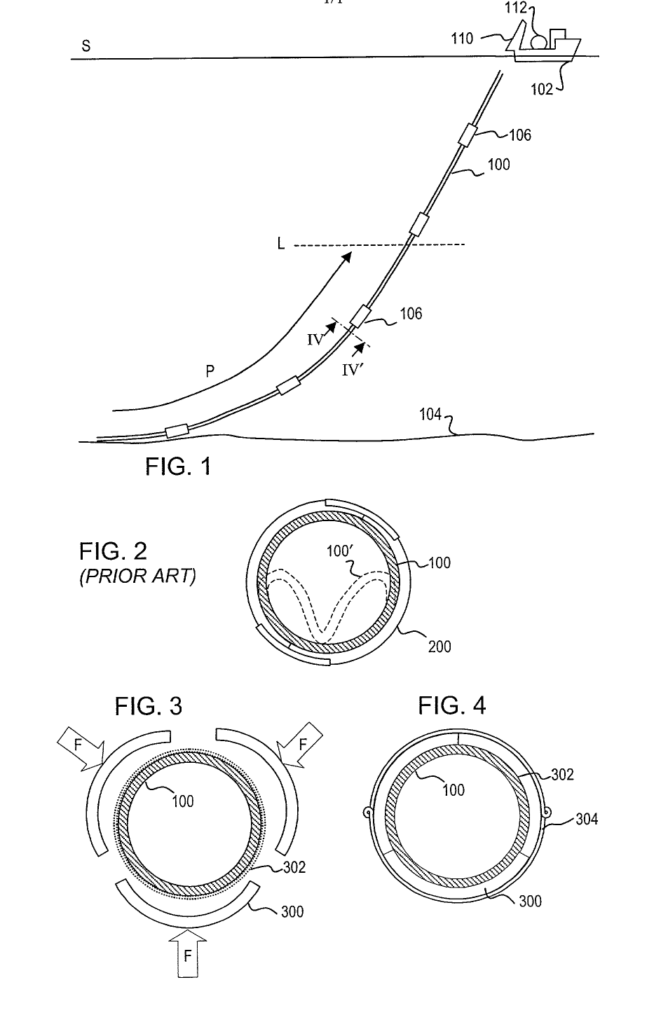

Referring now to FIG. 1, there is shown schematically a continuous pipeline 100 being laid from a vessel 102 at surface level S to the seabed 104. As mentioned in the introduction, conduits such as steel pipeline are subject to enormous pressure as the depth of water increases, and any defect or dent in the pipeline can initiate the rapid propagation of an axial or bifurcation along the pipeline as illustrated by arrow P in FIG. 1. This buckle propagates until, at a certain depth L, the water pressure is no longer sufficient to propagate the buckle. Needless to say, by this stage, many kilometers of pipeline may be lost, with the attendant problems mentioned in the introduction.

FIG. 2 illustrates prior approaches to arresting the propagation of such buckles. The pipeline 100 is shown in cross-section and external clamp arrangement 200 has been applied to increase the thickness and therefore rigidity of the pipeline at one or more points along its length.

The outline of the pipe after buckling is shown in broken lines at 100′. A simple external clamp 200 of known form appears limited in its ability to prevent the inward collapse of the pipe as shown.

Referring again to FIG. 1 in conjunction with FIGS. 3 and 4, a novel form of buckle arrestor 106 is applied in the present embodiment, in which the pipeline is positively bonded by use of adhesive to the interior of an externally applied clamp, thereby to prevent the inward collapse and arrest propagation of the buckle.

FIG. 3 illustrates a stage in the process of applying the novel device. In this case, the device comprises three part-cylindrical sections 300, each covering a circumferential angle of 120 degrees around the pipe, so as to make up together a cylindrical collar.

FIG. 4 shows the completed collar comprising sections 300 assembled on to the pipeline. Prior to assembly, adhesive 302 is applied to one or both of the meeting surfaces, and the segments 300 are applied on the pressure F so as to achieve a high-strength bonding of the external circuits of the pipe to the internal surface of the strengthening device.

The closing pressure F can be applied by a machine and released once the bond has been formed. Alternatively, or in addition, a further clamp 304 shown in FIG. 4 can be applied to achieve the same result, and/or to reinforce the bond when in use.

Referring again to FIG. 1, it will be seen that the vessel 102 comprises a tiltable laying ramp 110 suitable for paying out the pipeline at a steep angle, under considerable tension. A reel 112 is shown schematically, which may be loaded with a continuous length of pipe, which is then bent over the top of the ramp 110 and straightened prior to laying.

Instead of a ramp at the stern of the vessel, various other locations for ramps or towers are known, launching the pipe over one side of the vessel or through a moon pool or via a stinger in an S-Lay configuration.

The vessel and pipe laying arrangement may be as described in more detail. in US-A-5975802 mentioned above. In particular, instead of the reel 112 shown schematically in FIG. 1, the arrangement may feature a series of stations adapted to form a continuous pipe by welding individual sections together.

The device may conveniently be made of the material similar to that of the conduit being protected, generally steel. However, this is not necessarily the case, and the conduit and/or the buckle arrestor could also be made of a suitable plastic.

The thickness of the pipe wall and the additional thickness to be provided by the buckle arrestors will of course vary, depending on the installation depth, and other operational considerations. Similarly, the spacing of the buckle arrestors 106 will be selected according to mechanical and economic considerations. It will be understood that any section or pipeline between two of these devices will still be susceptible to collapse and need to be replaced by underwater operations. The spacing of the devices serves to limit the length to be replaced per buckling incident, and hence allows the economic risk to be limited. Safety is maintained in that the additional weight caused by the collapse of a single section can be designed to be well within the tolerance of the laying equipment.

Suitable adhesives for bonding the device to the pipeline would be of epoxy type resin. As alternatives to adhesive, welding, including radial friction welding, may be considered.

Various further modifications of the device and method will be envisaged by the skilled person and it will be appreciated that the invention is not limited in spirit or scope to the particular embodiments illustrated or described.

1. A method of protecting an underwater conduit against collapse, wherein at least one bracing device is applied around the external circumference of said conduit so as to define locally a region of increased wall thickness, and wherein an internal surface of said device is bonded to the external surface of said conduit so as to inhibit separation of the two surfaces and prevent collapse of said conduit.

2. A method as claimed in claim 1, wherein said device is applied during pipe laying operations.

3. A method as claimed in claim 2 wherein for such pipe laying operations in which said conduit is bent and then straightened as it is paid out, said device is applied after straightening of the pipe.

4. A method as claimed in any preceding claim wherein said device is an externally applied collar.

5. A method as claimed in claim 4 wherein said collar comprises a plurality of segments such that each segment is laid upon the conduits prior to tightening and fixing of said collar.

6. A method as claimed in claim 5 wherein an adhesive is applied to the mating surfaces of the conduit and the collar, which is then tightened in place.

7. A method as claimed in claims 5 or 6 wherein there are three segments in the collar.

8. A method as claimed in claims 5 or 6 wherein there are four segments in the collar, each forming a part-cylindrical surface for mating with the conduit.

9. A device for use as a buckle arrestor on an underwater conduit, said device comprising one or more parts adapted to be formed into a cylindrical collar surrounding and bonded to the external surface of said conduit so as to increase its thickness and resistance to inward collapse.

10. A device as claimed in claim 9 comprising a set of part-cylindrical segments adapted to form said cylindrical collar by fitting around and bonding to said conduit.

11. A device as claimed in claim 10 wherein the number of segments is three.

12. A device as claimed in claim 10 wherein the number of segments is four.

13. An underwater installation wherein rigid conduits are protected against inward collapse by the provision of bracing devices at regular intervals along a length of conduit, wherein each bracing device comprises one or more parts formed separately from the conduit and applied around the external circumference of the conduit so as to define locally a region of increased wall thickness, and wherein an internal surface of the device is bonded to the external surface of the conduit so as to inhibit separation of the two surfaces and prevent collapse of the conduit.

14. An underwater installation as claimed in claim 13 wherein sa id parts form a cylindrical collar.

15. An underwater installation as claimed in claims 13 or 14 wherein said bonding is made by adhesive.

16. An underwater installation as claimed in claim 15 wherein said adhesive is an epoxy resin.
